(19) United States
(12) Patent Application Publication
(10) Pub. No.: US 2017/0131091 A1
(43) Pub. Date: May 11, 2017

(54) MEASURING SURFACE GEOMETRY USING ILLUMINATION DIRECTION CODING

(71) Applicant: CANON KABUSHIKI KAISHA, Tokyo (JP)

(72) Inventors: Siu-Kei Tin, Milpitas, CA (US); Jinwei Ye, San Jose, CA (US)

(21) Appl. No.: 14/937,648

(22) Filed: Nov. 10, 2015

(51) Int. Cl. G01B 11/25; G01B 11/22; G06T 7/40

(52) U.S. Cl. CPC G01B 11/25; G06T 7/40; G01B 11/22

(57) ABSTRACT

Measuring a surface geometry of an object involves capturing one or more images of the object illuminated by a light field produced by one or more luminaires having multiple pixel-layers with overlapping fields of illumination. Each pixel-layer simultaneously and in synchronization with each other displays multiple coded patterns such that combinations of the multiple coded patterns uniquely identify directions of light rays originating from the multiple pixel-layers. A unique incident light ray direction for each pixel of the captured one or more images is determined by decoding the combinations of the multiple coded patterns. The surface geometry of the object is recovered using the determined unique incident light ray direction for each pixel of the one or more captured images.

### FIELD

The present disclosure relates to measurement of surface geometry, and more particularly relates to measuring the shape of an object using illumination.

### BACKGROUND

Objects fabricated from a highly glossy or specular material have reflection characteristics that differ significantly from those fabricated from a diffuse material. For example, where for a diffuse material, light from a directional light source such as a projector is reflected in virtually all directions, for a highly glossy material, such light is reflected in primarily only one direction or at most only a few directions. As a consequence, conventional 3D scanning methods such as structured light and photometric stereo typically do not perform well when applied to objects fabricated from a highly glossy material.

### SUMMARY

A number of alternative techniques for measuring the surface geometry of highly glossy objects have been considered. One example technique is continuous area illumination, where the light source used to illuminate the object is composed of a high density of light-producing or light-modulating pixels and each pixel is dynamically programmable in its intensity and/or color. One example of a continuous area light source is a common color display. Because of the practically continuous area light source, every surface point of the object is illuminated in a continuous range of angles, and a camera set at a fixed predetermined position can observe a specular reflection. For measurement efficiency, techniques of continuous area illumination typically display a sequence of patterns on the display, instead of displaying one pixel at a time. A common choice of such patterns is based on the Gray code.

Techniques of continuous area illumination typically assume either that the continuous area light source is far away from the object (e.g. far field illumination) and/or that the object being measured is nearly flat. This is because continuous area illumination typically involves determining the location of a pixel on the light source that is causing a specular reflection at a point on the object. This information, however, cannot be used to uniquely determine the direction of the incident light ray, and in turn the depth at that point of the object, without making an additional assumption such as a distant light source or a nearly flat object. This phenomenon is sometime referred to as the “depth-normal ambiguity”.

To resolve the depth-normal ambiguity without assuming one of either a distant light source or a nearly flat surface, it has been considered to perform continuous area illumination using multiple layers of displays (e.g. multiple LCD displays). See, for example, U.S. application Ser. No. 14/489,008, filed Sep. 17, 2014 and assigned to the Applicant herein, entitled “Depth Value Measurement Using Illumination By Pixels” by Siu-Kei Tin and Mandi Nezamabadi (herein after “Tin et al.”), which is incorporated herein by reference as if set forth herein in full.

One difficulty with the foregoing approach is that the number of image captures required is directly proportional to the number of layers of displays used. For example, a method that uses two LCD displays in order to resolve the depth-normal ambiguity without any additional assumptions would ordinarily require twice the number of image captures.

The foregoing difficulty is addressed by displaying patterns on the multiple layers of displays that encode only the direction of incident light rays, and by arranging the multiple layers of displays and the object being measured in such a way that only the light rays that strike the object are encoded. This allows for the patterns to be displayed on each layer of the display simultaneously and in synchronization with each other while still encoding sufficient information to determine only the direction of the incident light rays. This allows for a reduction of the number of required image captures when compared to previous methods which typically require patterns to be displayed on each layer separately in order to encode both direction and position of the incident light rays.

Thus, in an example embodiment described herein, measuring a surface geometry of an object involves capturing one or more images of the object illuminated by a light field produced by a luminaire having multiple pixel-layers with overlapping fields of illumination. Each pixel-layer simultaneously and in synchronization with each other displays multiple coded patterns such that combinations of the multiple coded patterns uniquely identify directions of light rays originating from the multiple pixel-layers. A unique incident light ray direction for one or more pixels of the captured one or more images is determined by decoding the combinations of the multiple coded patterns. The surface geometry of the object is recovered using the determined unique incident light ray direction for each of the one or more pixels of the one or more captured images.

Because of this arrangement, it is ordinarily possible to measure the surface geometry of a highly specular object without assuming a distant light source or a nearly flat object, and to do so using a reduced number of image captures.

In examples of this arrangement, recovering the surface geometry of the object may involve determining a surface normal vector field of the object based on the determined unique incident light ray direction for each of the one or more pixels of the one or more captured images.

In other examples, recovering the surface geometry of the object may involve determining points on the surface of the object by triangulation of the unique incident light ray direction and a viewing direction from a camera for each of the one or more pixels of the one or more captured images.

The combinations of the multiple coded patterns displayed by the multiple pixel-layers can encode differences in pixel location coordinates of pixels located on two of the multiple pixel-layers. In some examples, each pixel of a pixel-layer is associated with an admissible cone that determines a maximum difference in pixel location coordinates that can be encoded.

The pixels in the multiple pixel-layers may have the same dot pitch and aspect ratio. At least two of the multiple pixel-layers may largely be in parallel to each other and separated by a perpendicular distance. Additionally, the multiple pixel-layers may be positioned such that they are laterally shifted relative to each other.

The multiple coded patterns may be based on a binary Gray code. Moreover, a minimum-run-length (MRL) of the binary Gray code may determine a maximum difference in pixel location coordinates of pixels located on two of the multiple pixel-layers that can be encoded. In one example, the minimum-run-length of the binary Gray code is 8.

In another example embodiment described herein, an apparatus for measuring a surface geometry of an object includes a plurality of luminaires. Each luminaire includes multiple pixel-layers with overlapping fields of illumination and the luminaires are positioned to surround the object. The apparatus further includes a pattern displaying module constructed to cause each pixel-layer of each luminaire to simultaneously and in synchronization with each other display multiple coded patterns. Combinations of the multiple coded patterns may uniquely identify directions of light rays originating from the multiple pixel-layers of each luminaire and may uniquely identify each luminaire. The apparatus further includes an image capture device constructed to capture one or more images of the object. A direction determining module is constructed to determine, for each pixel of the captured one or more images, a unique light ray direction by decoding the combinations of the multiple coded patterns. A depth recovering module is constructed to recover the surface geometry of the object using the determined unique incident light ray direction for each pixel of the one or more captured images.

In some examples, the direction determining module determines the unique light ray direction in steps that include determining an identity of one of the luminaires that the light ray originates from, by decoding the combinations of the multiple coded patterns.

In some examples of the apparatus, pixels in the multiple pixel-layers of a luminaire of the plurality of luminaires may have the same dot pitch and aspect ratio.

Some embodiments may be implemented as a method or methods according to any of the disclosure herein. Some embodiments may be implemented as an apparatus or apparatuses according to any of the disclosure herein. Representative embodiments of such apparatus may be implemented as one or more processors constructed to execute stored process steps together with memory, which stores the process steps described herein for execution by the processor(s). Other representative embodiments of such apparatus may be implemented as units constructed to execute processes described herein, with such units, for example, being implemented by computer hardware in combination with software which when executed by the computer hardware causes the computer hardware to execute such processes. Some further embodiments may be implemented as non-transitory computer-readable storage media, which retrievably store computer-executable process steps which when executed by a computer cause the computer to execute such process steps.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 illustrates an example embodiment of an environment in which aspects of the present disclosure may be practiced.

FIGS. 2A and 2B are views for explaining the architecture of a system for illumination direction coding according to an example embodiment.

FIG. 3 is a view for explaining various terminology used in the example embodiments described herein.

FIG. 4 is a view illustrating a visualization of a “long run” Gray code pattern according to an example embodiment.

FIG. 5 is a view illustrating an example system for illumination direction coding using a single luminaire.

FIG. 6 is a flow diagram for explaining a process for illumination direction coding according to an example embodiment.

FIG. 7 is a view illustrating an example system for illumination direction coding incorporating a plurality of luminaires.

FIGS. 8, 9 and 10 are views illustrating a series of binary patterns according to an example embodiment.

FIG. 11 is a plot of results for the example system of FIG. 7 incorporating a plurality of luminaires.

### DETAILED DESCRIPTION

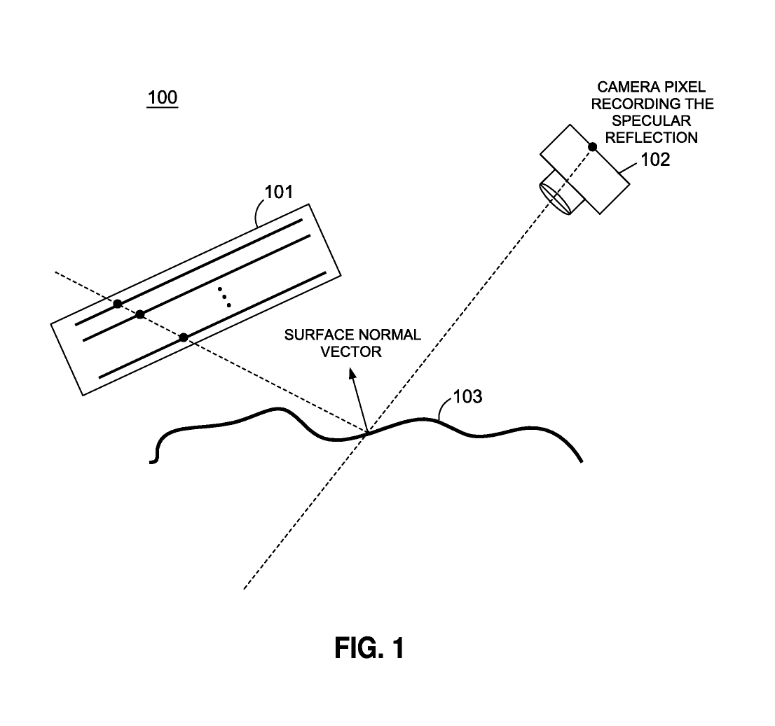

FIG. 1 illustrates an example embodiment of an environment in which aspects of the present disclosure may be practiced.

In particular, as shown in FIG. 1, luminaire 101, comprising multiple pixel-layers, each pixel layer including an array of pixels, effects illumination of the surface of an object 103.

Meanwhile, specular reflections caused by the illumination are captured by image capture device 102. For purposes of clarity, FIG. 1 depicts a single specular reflection at a point on the surface of object 103, and image capture device 102 captures and records the reflection in a corresponding single camera pixel. It should be understood that such specular reflection may be occurring at multiple points on the surface of object 103 and captured in multiple camera pixels of image capture device 102 at the same time. Moreover, additional embodiments may include multiple cameras, multiple or larger luminaires, and the like, as discussed below.

As shown in FIG. 1, illumination with luminaire 101 uses N pixel-layers, where N≧2. In embodiments described herein, the N pixel-layers are largely in parallel to each other and are separated by a perpendicular distance. As further described below, the N pixel-layers are positioned such that they are laterally shifted to each other, introducing a “shear” between them.

A backlight may be used in some embodiments to provide the light source. On the other hand, in some embodiments a backlight may be optional.

Luminaire 101 may be manufactured so that distances between the pixel-layers can be predetermined with high accuracy and precisions. Alternatively, the pixel-layers can be geometrically calibrated in an offline calibration process. Either way, since there is ordinarily no movement of the stack as a whole or relative movement of the layers within the stack during the online measurement process, it can be assumed that these distances and other geometric parameters are known without an online calibration step.

Each pixel-layer, or at least one pixel-layer, may be an array of spatial light modulator (SLM) pixels and not self-luminous. Examples of SLM pixels include liquid crystal display (LCD) pixels and digital micromirror device (DMD) pixels. In alternative examples, each pixel-layer may be an array of light emitting diodes (LEDs) and self-luminous.

According to the disclosure, a light pattern results from one or more coded patterns transmitted to the pixel-layers. A pixel-layer might include a 2-dimensional array of pixels, in which case there is a pixel resolution associated with each dimension, e.g., 1920×1080. A pixel ordinarily does not need to be self-luminous, i.e., it does not need to emit light by itself. For example, in a typical LCD display, there is a backlight source and the LCD panel modulates the backlight based on the image signal. In addition, in a color LCD display, each pixel consists of different color sub-pixels and is capable of modulating light intensity in different wavelength ranges and of displaying colors.

Although image capture device 102 is depicted as a camera, it should be understood that various other image capture devices can be used.

According to the arrangement shown in FIG. 1, it is ordinarily possible to measure a depth value using a system which is relatively compact and which does not require re-calibration by capturing an image of an object illuminated by a light field produced by the multiple pixel-layers of luminaire 101. Specifically, each pixel-layer simultaneously and in synchronization with each other displays multiple coded patterns such that combinations of the multiple coded patterns uniquely identify directions of light rays originating from the multiple pixel-layers. A unique incident light ray direction is determined for pixels of the captured image by decoding the combinations of the multiple coded patterns, and the surface geometry of the object is recovered using the determined unique incident light ray direction for each pixel of the captured image, as discussed more fully below.

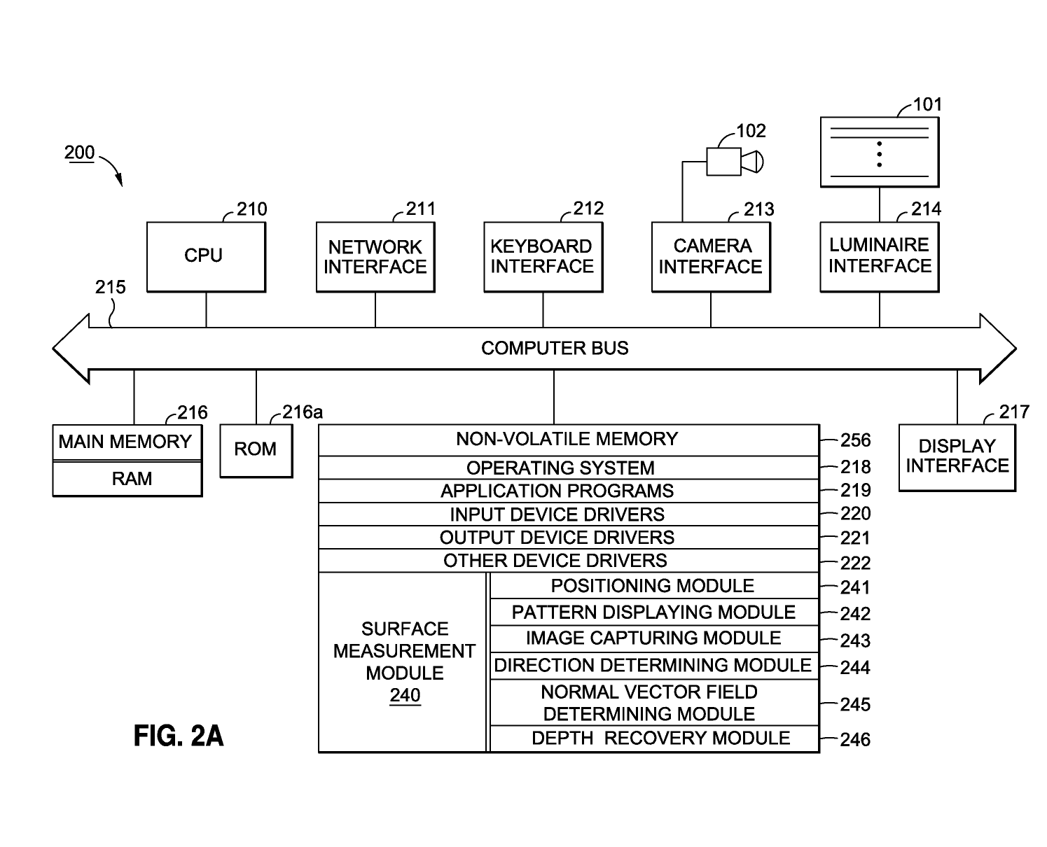

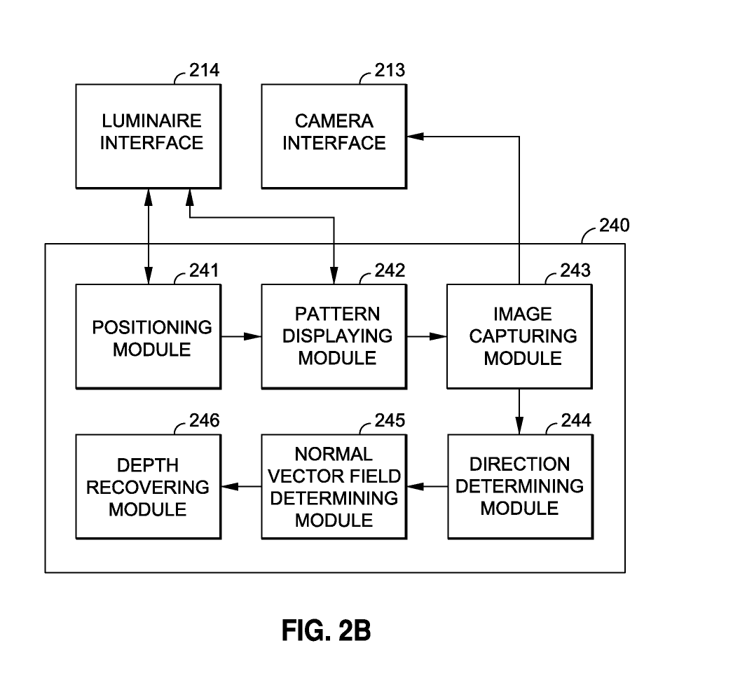

FIG. 2A is a view for explaining the architecture of a system 200 for controlling illumination direction coding according to an example embodiment. The system 200 is shown in FIG. 2A as a standalone computer constructed to interface with camera 120 and luminaire 101; however, the functionality of system 200 can also, for example, be incorporated into camera 120 itself.

As shown in FIG. 2A, system 200 includes central processing unit (CPU) 210, which interfaces with computer bus 215. Also interfacing with computer bus 215 are non-volatile memory 256 (e.g., a hard disk or other nonvolatile storage medium), network interface 211, keyboard interface 212, camera interface 213, random access memory (RAM) 216 for use as a main run-time transient memory, read only memory (ROM) 216a, and display interface 217 for a display screen or other output.

RAM 216 interfaces with computer bus 215 so as to provide information stored in RAM 216 to CPU 210 during execution of the instructions in software programs, such as an operating system, application programs, image processing modules, and device drivers. More specifically, CPU 210 first loads computer-executable process steps from non-volatile memory 256, or another storage device into a region of RAM 216. CPU 210 can then execute the stored process steps from RAM 216 in order to execute the loaded computer-executable process steps. Data can also be stored in RAM 116 so that the data can be accessed by CPU 210 during the execution of the computer-executable software programs, to the extent that such software programs have a need to access and/or modify the data.

As also shown in FIG. 2A, non-volatile memory 256 contains computer-executable process steps for operating system 218, and application programs 219, such as graphic image management programs. Non-volatile memory 256 also contains computer-executable process steps for device drivers for software interface to devices, such as input device drivers 220, output device drivers 221, and other device drivers 222.

Non-volatile memory 256 also stores a surface measurement module 240. The surface measurement module 240 comprises computer-executable process steps for determining the surface geometry of an object based on illumination based direction coding.

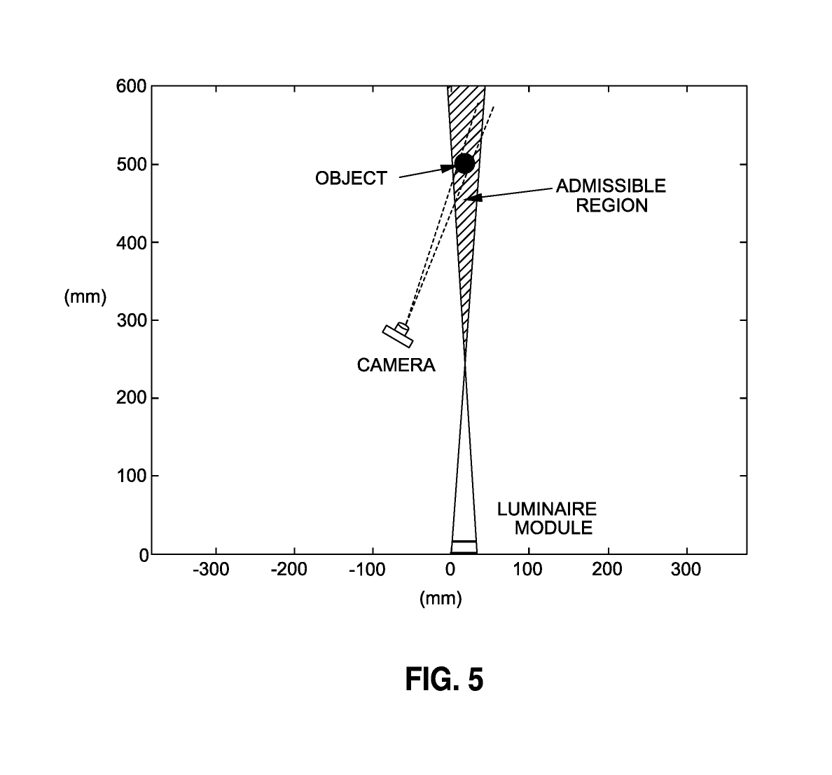

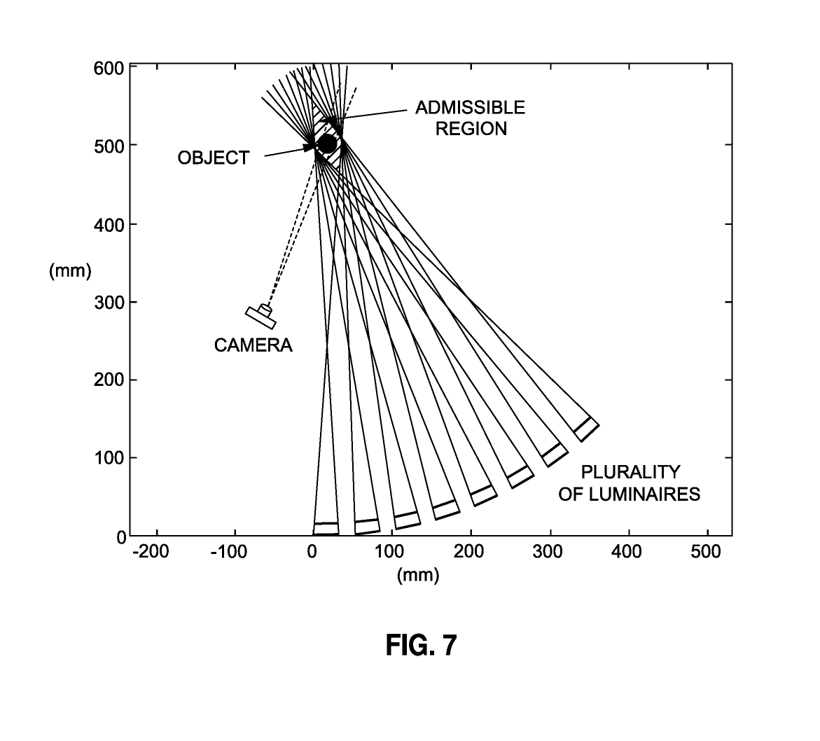

As shown in FIG. 2A, surface measurement module 240 generally includes positioning module 241 for positioning an object relative to one or more luminaires (e.g. luminaire 101), as described more fully below with respect to, for example, FIGS. 5 and 7. Also included in surface measurement module 240 is pattern displaying module 242 for illuminating the object using a light field produced by multiple pixel-layers of the one or more luminaires having overlapping fields of illumination. Each pixel-layer simultaneously and in synchronization with each other displays multiple coded patterns such that combinations of the multiple coded patterns uniquely identify directions of light rays originating from the multiple pixel-layers of the one or more luminaires. Image capturing module 243 is for capturing one or more images of the object as it is illuminated with the multiple coded patterns using image capture device 102. Direction determining module 244 is for determining a unique incident light ray direction for one or more pixels of the captured images by decoding the combinations of the multiple coded patterns. Normal vector field determining module 245 is for determining a surface normal vector field of the object based on the determined unique incident light ray directions for each of the one or more pixels. Depth recovery module 246 is for determining points on the surface of the object from the determined surface normal vector field or by triangulation of the unique incident light ray direction and a viewing direction for each of the one or more pixels of the captured images.

These modules will be discussed in more detail below with respect to FIG. 2B.

The computer-executable process steps for these modules may be configured as part of operating system 218, as part of an output device driver in output device drivers 221, or as a stand-alone application program. These modules may also be configured as a plug-in or dynamic link library (DLL) to the operating system, device driver or application program. It can be appreciated that the present disclosure is not limited to these embodiments and that the disclosed modules may be used in other environments.

FIG. 2B is a view for explaining surface measurement module 240 according to an example embodiment. As previously discussed with respect to FIG. 2A, surface measurement module 240 comprises computer-executable process steps stored on a non-transitory computer-readable storage medium, such as non-volatile memory 256.

As shown in FIG. 2B, surface measurement module 240 includes positioning module 241 for positioning an object relative to one or more luminaires. The object might be placed manually in a designated region in the measurement system or apparatus, such as an “admissible region” described in the following. The object might also be rotated manually or automatically using a motorized rotary stage driven by a stepper motor. As discussed above, pattern displaying module 242 communicates with luminaire interface 214 and is for illuminating the object with multiple coded patterns such that combinations of the multiple coded patterns uniquely identify directions of light rays originating from the multiple pixel-layers of the one or more luminaires. Image capturing module 243 is for capturing one or more images of the object as it is illuminated with the multiple coded patterns and communicates with camera interface 213, and is configured to receive image data from the image capture device. The resultant images may be stored, for example in non-volatile memory 256. Direction determining module 244 uses the image captured by image capture module 243 to determine a unique incident light ray direction for one or more pixels of the captured images by decoding the combinations of the multiple coded patterns.

Normal vector field determining module 245 determines a surface normal vector field of the object based on the unique light ray directions determined by direction determining module 244. Depth recovering module 246 determines points on the surface of the object from the determined surface normal vector field or by triangulation of the unique incident light ray direction and a viewing direction for each of the one or more pixels of the captured images. The determined unique incident light ray directions, surface normal vector field, and determined points on the surface of the object may all be stored with the image data, for example, in non-volatile memory 256.

Returning to FIG. 1, there are two key insights that form the basis of the illumination direction coding methods and systems described herein.

First, the multiple pixel-layers of the luminaire 101 produce a light field that illuminates the object 103. In particular, for the case of N=2 layers, the light field consists of light rays joining a pixel on one pixel-layer to another pixel on another pixel-layer. layer. If both pixel-layers are 2-dimensional arrays of pixels with horizontal pixel resolution rₓ and vertical pixel resolution r_{y}, for example rₓ=1920, r_{y}=1080 for display panels of resolution 1920×1080, the size of this light field is (rₓr_{y})² , so that a binary encoding of the full light field would require 2(log₂ rₓ+log₂ r_{y}) bits.

However, not all of the light rays produced by the multiple pixel-layers are needed. In particular, it is possible to arrange the pixel-layers and the object 103 in such a way that some of the light rays would never hit the object. Such an arrangement would allow for encoding of only the useful light rays that hit the object, so that the number of bits required can be reduced. As explained more fully below, this is accomplished by introducing the concept of an “admissible cone” for each pixel.

The second key insight is that the encoding of each light ray generally includes both its position and direction. However, in applications involving the reconstruction of the normal vector field of the object, it is only necessary to determine the direction of the light rays. Further saving can therefore be achieved by encoding only the direction of the light rays in the admissible cone.

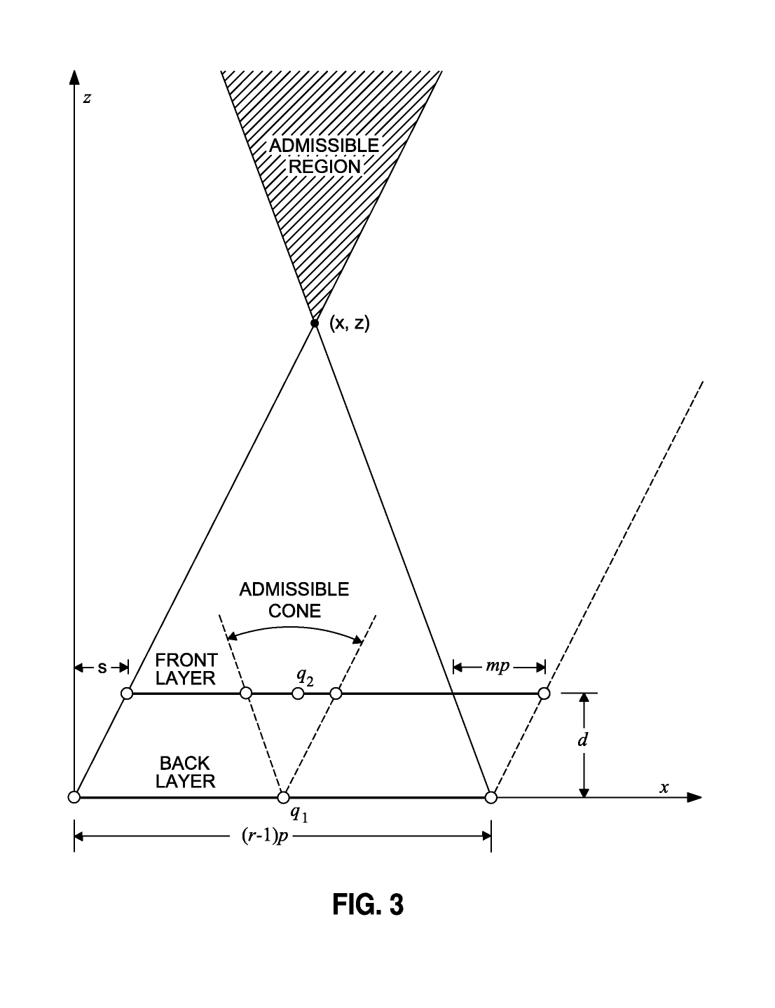

FIG. 3 is a view (in 2D) for explaining various terminology used in the foregoing descriptions.

In FIG. 3, two identical pixel-layers (e.g. a front pixel-layer and a back pixel-layer) with the same pixel resolution r×r and same pixel pitch size or dot pitch p are separated by a distance d. In this embodiment, the two (identical) pixel-layers have the equal horizontal pixel resolution and vertical pixel resolution, i.e., rₓ=r_{y}=r, and pixel aspect ratio is p:p, or 1:1. In another embodiment, the two (identical) pixel-layers may have horizontal pixel resolution rₓ and vertical pixel resolution r_{y} such that rₓ≠r_{y} and may have a pixel aspect ratio different from 1:1. Instead of perfectly aligning the two pixel-layers, a “shear” s is introduced between the two pixel-layers. In other words, the pixel-layers are positioned such that they are laterally shifted relative to each other by a distance s. This has the effect that a light ray joining corresponding pixels of the same position index is now slanting and will form one boundary of an admissible cone, as shown, for example, at pixel q₁ on the back pixel-layer. The shear is typically a small distance, e.g., s=1.07 mm, so that the two pixel-layers have a relatively large overlap of fields of illumination. In other words, light rays that illuminate the object would have passed through pixels on both pixel-layers.

The other boundary of the admissible cone is controlled by a parameter m, which determines the number of light rays in the admissible cone. As further shown in FIG. 3, which depicts a 2D situation, there are m+1 light rays in the admissible cone associated with pixel q₁. In the 3D case, there are (m+1)² rays in an admissible cone. Mathematically, the admissible cone at pixel q₁ on the back pixel-layer is defined as:

Γ(q₁)=Γ₀₀(q₁)={\vec{q₁q₂}|q₁ₓ−m≦q₂ₓ≦q₁ₓ,q_{1y}−m≦q_{2y}≦q_{1y}} (Equation 1)

In Equation 1, the subscripts x and y signify taking the position index in the x and y directions respectively. Note that this is a “one-sided” cone. Also, within the cone, pixel location coordinates of q₁ and q₂ are bounded by m, which is a maximum difference in pixel location coordinates that can be encoded. Three other alternative choices of the admissible cone are:

$${Γ}_{01} ( {q}_{1} ) = \{ \begin{matrix}\vec{{q}_{1} {q}_{2}} \vert {q}_{1 x} - m \leq {q}_{2 x} \leq {q}_{1 x} , \\ {q}_{1 y} \leq {q}_{2 y} \leq {q}_{1 y} + m\end{matrix} \} \\ {Γ}_{10} ( {q}_{1} ) = \{ \begin{matrix}\vec{{q}_{1} {q}_{2}} \vert {q}_{1 x} \leq {q}_{2 x} \leq {q}_{1 x} + m , \\ {q}_{1 y} - m \leq {q}_{2 y} \leq {q}_{1 y}\end{matrix} \} \\ {Γ}_{11} ( {q}_{1} ) = \{ \begin{matrix}\vec{{q}_{1} {q}_{2}} \vert {q}_{1 x} \leq {q}_{2 x} \leq {q}_{1 x} + m , \\ {q}_{1 y} \leq {q}_{2 y} \leq {q}_{1 y} + m\end{matrix} \} \qquad ( Equations 2 \text{-} A , 2 \text{-} B and 2 \text{-} C )$$

In Equations 1 and 2-A to 2-C, the choice of m is dependent on available coding schemes, as explained more fully below. The choice of m is typically a small number, e.g., m=8.

By running through all the pixels q₁ on the back pixel-layer, the admissible region for the whole luminaire can be obtained and is defined as the region in space where every individual admissible cone can affect:

$$Ω = {⋂}_{{q}_{1}} Γ ( {q}_{1} ) \qquad ( Equation 3 )$$

The admissible region is a cone itself with its vertex at (X, Y, Z) given by:

$$X = Y = \frac{r - 1}{m} s \\ Z = \frac{r - 1}{m} d \qquad ( Equations 4 A and 4 B )$$

When an object is within the admissible region of the luminaire, it is subjected to a light field with only (m+1)² directions even though the luminaire provides a light field with a nominal r² number of directions.

The (m+1)² directions cannot be directly encoded. More specifically, an individual light ray in the illumination field cannot be turned on or off directly, but instead, is controlled by turning on or off pixels in the pixel-layers. In other words, illumination direction coding is achieved via coding patterns that are displayed on the pixel-layers.

Accordingly, in the example of FIG. 3, combinations of multiple coded patterns displayed by the two pixel-layers can encode differences in pixel location coordinates of pixels located on the two pixel-layers. Each pixel of a pixel-layer is associated with an admissible cone that determines a maximum difference in pixel location coordinates that can be encoded. The pixels in the two pixel-layers may have the same dot pitch and aspect ratio. The two pixel-layers may largely be in parallel to each other and separated by a perpendicular distance. Additionally, as mentioned above, the two pixel-layers may be positioned such that they are laterally shifted relative to each other. An example of an applicable coding framework is described below.

### <General Encoding Framework>

The objective of the coding framework is to design a series of binary coded patterns to be displayed on multiple pixel-layers such that if a light ray \vec{q₁q₂} causes a reflection observed by a pixel of an image capturing device, a sequence of readings at that camera pixel (when different patterns are displayed) would allow for the recovery of q₂ₓ−q₁ₓ and q₂−q_{1y}. These quantities in turn allow for a determination of the direction of \vec{q₁q₂}, but not a position. Because the admissible cone is one-sided, the signs of these quantities are predetermined, and it is sufficient to recover |q₂ₓ−q₁ₓ| and |q_{2y}−q_{1y}|.

It is typical for independent coded patterns to be designed for the x and y directions, i.e., the coded patterns are vertical and horizontal stripes respectively. The following description can be applied to either x or y direction, where qᵢ is identified with q₁ₓ, and q_{1y}, and q₂ is identified with q₂ₓ and q_{2y}, etc.

For an example n, a general method of designing n binary coded vertical striped patterns (respectively horizontal striped patterns) on r pixels on one pixel-layer in the horizontal direction (respectively in the vertical direction) is as follows. A mapping is first chosen where ψ: {0,1,2, . . . , r−1}→{0,1,2, . . . , 2ⁿ−1}. Then the n binary coded patterns at pixel q ∈{0,1,2, . . . , r−1} are given by the binary vector βₙ (Ψ(q)) ∈(Z/2Z)ⁿ, where βₙ denotes the conversion of a number to its binary bit vector representation. The Gray code (of which the standard Gray code, also called the reflected Gray code, is a special case) corresponds to the case that Ψ=Ψ_{RGC} is a permutation on the 2ⁿ symbols and successive code words βₙ (Ψ_{RGC} (q)) and βₙ (Ψ_{RGC} (q+1)) differ only in one coordinate or bit position.

The method in Tin et al. uses the reflected Gray code and can be considered a special case of this formulation where the patterns on two pixel-layers are given by two mappings Ψ₁=2^{┌log}^{₂}_{r┐}Ψ_{RGC} and Ψ₂=Ψ_{RGC}. The range of the target space of these mappings ({0,1,2, . . . ,2^{2┌log}^{₂}_{r┐}−1}) determines the number of required image captures, which is 2┌log₂r┐.

The general problem of determining suitable codes on two pixel-layers can be formulated as the problem of finding a suitable n and suitable mappings Ψ₁, Ψ₂ such that |q₂−q₁} is uniquely determined by βₙ (Ψ(q₁))+βₙ (Ψ₂(q₂)). |q₂−q₁| is a difference in pixel location coordinates of pixels located on two of the multiple pixel-layers. Thus, when a first pixel-layer displays n binary coded patterns that correspond to βₙ·Ψ₁ and simultaneously a second pixel-layer displays n binary coded patterns that correspond to βₙ ·Ψ₂ synchronization with the first pixel-layer in the sense that both pixel-layers are displaying the ith bit plane simultaneously, the combinations of the coded patterns correspond precisely to the vector sum of binary n-dimensional vector functions of the pixel coordinates βₙ ·Ψ₁+βₙ ·Ψ₂. Because a direction of light ray originating from the pixel-layers is uniquely identified by the difference |q₂−q₁|, solving this coding problem allows a direction of light ray originating from the pixel-layers to be uniquely identified by a combination of binary coded patterns.

Noting that the binary vector addition is component-wise mod 2 addition, or XORing (i.e., applying the exclusive-or operation), this models precisely the 90° rotation of polarization of light by each pixel-layer when the pixel-layers are comprised of LCD pixels. In other words, the binary vector sum is precisely what is recorded by the image capture device.

If Ψ₁=Ψ₂=Ψ_{RCC} is chosen, then by construction of the reflected Gray code, |q₂−q₁|=d_{H} (βₙ (Ψ_{RGC} (q₁)) βₙ (Ψ_{RGC} (q₂)),0) if q₂−q₁=±2 , where d_{H} is the Hamming distance. Using the reflected Gray code as the coding scheme, only m=2 can be chosen, i.e., the admissible cone has only (m+1)²=9 light rays.

Accordingly, there exist other more specialized Gray codes with better properties for purposes of the embodiments described herein. For example, Goddyn and Gvozdjak, “Binary Gray Codes with Long Bit Runs”, Electronic Journal of Combinatorics, 2003, describes certain long run Gray codes having a large minimum-run-length (MRL). If Ψ_{GG} denotes the associated mapping and m=mrl(Ψ_{GG}) its minimum-run-length, then |q₂−q₁|=d_{H}(βₙ(Ψ_{GG}(q₁))+βₙ(Ψ_{GG}(q₂)),00 if |q₂−q₁≦m. In other words, by choosing m to be the minimum-run-length (MRL) of the binary Gray code, the minimum-run-length (MRL) of the binary Gray code determines a maximum difference in pixel location coordinates of pixels located on two of the multiple pixel-layers that can be encoded.

Using the long run Gray code of Goddyn and Gvozdjak, |q₂−q₁| is uniquely determined by βₙ(Ψ_{GG}(q₁))+βₙ(Ψ_{GG}(q₂)) if q₂ lies within the admissible cone of q₁.

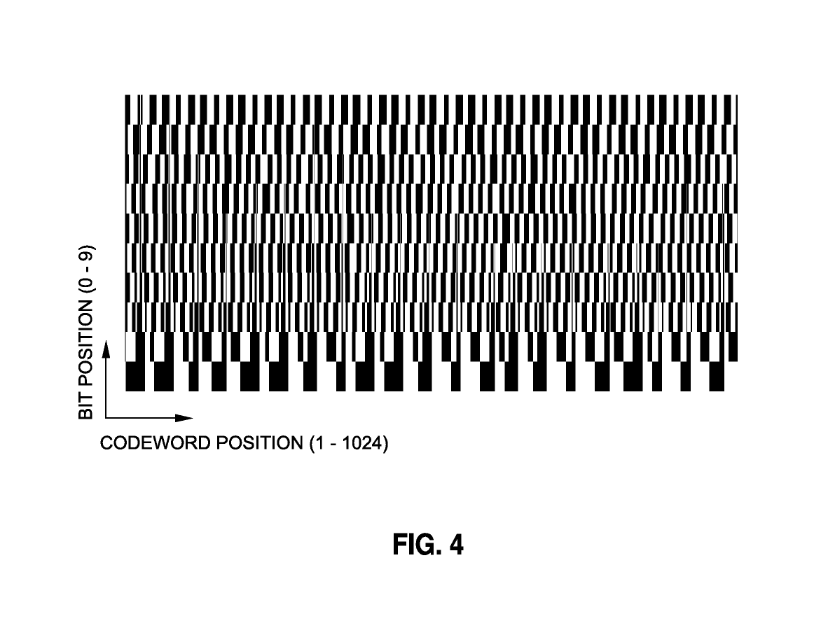

In particular, a 10-bit code (i.e., n=10) can be constructed that has a minimum-run-length of m=8. FIG. 4 is a visualization of this code, which depicts 10 sequences of binary digits (bits) each of length 1024 as 10 rows of vertical stripes where each row is characterized by a “bit position”.

FIG. 5 is a view illustrating an example system for illumination direction coding using a single luminaire and implementing the coding framework described above.

As shown in the figure, the front pixel-layer and the back pixel-layer are largely in parallel to each other. Example values of parameters for the system of FIG. 5 are as follows: p=0.25 mm (horizontal and vertical pixel pitch or dot pitch, so that the pixel aspect ratio is 1:1), r=128 (horizontal and vertical pixel resolution of both LCD layers), d=15 mm (perpendicular distance of separation between the two layers), s=1.07 mm (shear distance in both horizontal and vertical directions, or lateral shift of the two pixel-layers relative to each other) and m=8 (using the Goddyn-Gvozdjak 10-bit Gray code).

According to the above parameters, the system of FIG. 5 has an approximate angular resolution of

$$0.5 \frac{p}{d} \frac{180 °}{π} = 0.48 °$$

for resolving normal vectors. Use of 10-bit long run Gray code requires a minimum of 20 image captures (horizontal and vertical stripes based on the 10-bit Goddyn-Gvozdjak “long run” Gray code simultaneously displayed on the two pixel-layers). To the contrary, if the method described in Tin, et al. is applied to this setup, then a theoretical minimum of 28 image captures is required (horizontal and vertical stripes based on the 7-bit reflected Gray code displayed separately on each pixel-layer).

Also described in Tin, et al. is the use of inverse patterns for more robust binarization of the captured images. This can also be implemented in the coding scheme of the example embodiments described herein. More specifically, using the identity ˜xor(x, y)=xor(˜x, y)=xor(x,˜y), the binary patterns can be inverted on one of the pixel-layers. Using these extra coded patterns, the number of image captures required is 40, whereas the number of image captures required in the method of Tin, et al. is 56.

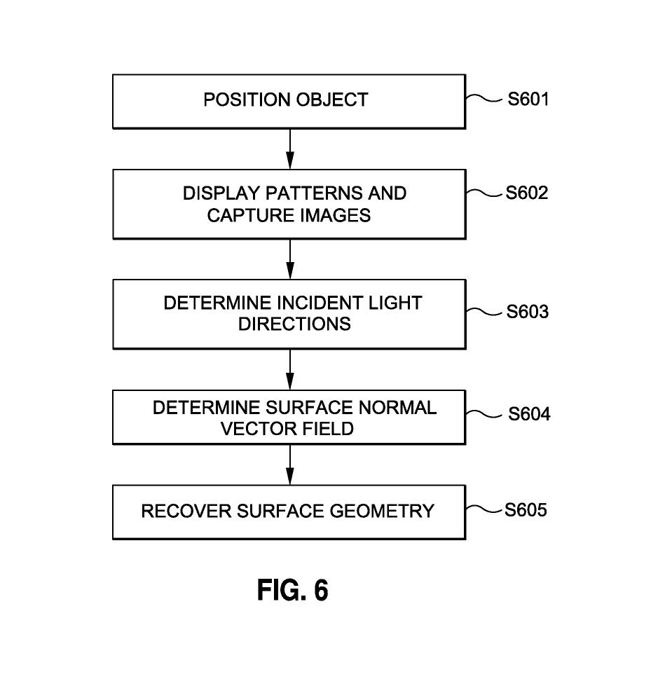

FIG. 6 is a flow diagram for explaining a process for illumination direction coding according to an example embodiment.

Briefly, in FIG. 6, one or more images are captured of an object illuminated by a light field produced by a luminaire having multiple pixel-layers with overlapping fields of illumination. Each pixel-layer simultaneously and in synchronization with each other displays multiple coded patterns such that combinations of the multiple coded patterns uniquely identify directions of light rays originating from the multiple pixel-layers. A unique incident light ray direction for each pixel of the captured one or more images is determined by decoding the combinations of the multiple coded patterns. The surface geometry of the object is recovered using the determined unique incident light ray direction for each pixel of the one or more captured images.

In step S601, an object is positioned relative to a luminaire such that the object lies within the admissible region of the luminaire. In further embodiments described more fully below, a plurality of luminaires may also be used, and the object is positioned within the admissible region of the plurality of luminaires. The admissible region of the plurality of luminaires is the intersection of all admissible regions of the individual luminaires.

In step S602, multiple coded patterns, based on the encoding framework described above (e.g., based on the long run Gray code), are displayed simultaneously and in synchronization with each other on each pixel-layer of the luminaire such that combinations of the multiple coded patterns (e.g., combinations resulting from XORing of binary patterns or component-wise addition of binary vectors) uniquely identify directions of light rays originating from the multiple pixel-layers, and one or more images are captured of the object as it is illuminated by the multiple coded patterns.

In step S603, a unique incident light ray direction for each pixel of the captured one or more images is determined by decoding the combinations of the multiple coded patterns. Decoding the combinations of the multiple coded patterns includes recovering the XORed binary patterns from the captured images. While the individual patterns before XORing cannot be recovered from the captured images, the XORed binary patterns can be recovered from the capture images. This typically involves binarizing the captured images, i.e., conversion of the captured color or grayscale images into binary, black and white images. Each binarized image corresponds to a recovered bit plane, and a full set of n binarized images corresponds to a full set of n bit planes, which is precisely the image βₙ·Ψ₁+βₙ·Ψ₂.

In step S604, a surface normal vector field of the object is determined based on the determined unique incident light ray direction for each of the one or more pixels of the one or more captured images, for example, by calculating the half-way vector between the incident light ray direction and the viewing direction from a camera for each of the one or more pixels of the one or more captured images, or by using the methods described previously in Tin et al.

In step S605, the surface geometry of the object is recovered by determining points on the surface of the object from the determined surface normal vector field, or by triangulation of the unique incident light ray direction and a viewing direction from a camera for each of the one or more pixels of the one or more captured images.

In one embodiment, the depth map of the object is recovered by integrating the determined normal vector field. More specifically, the gradients ∂H/and ∂x and ∂H/∂y are determined from the normal vector field, where H(z) is in turn a function of the depth z. In the case of an orthographic camera, H(z)=z, whereas in the case of a perspective camera, H(z)=lnz. In either case, integration of the gradient field recovers H(z) and, in turn, depth z.

In another embodiment, points on the surface of the object are determined by triangulation. Generally, if the incoming illumination ray is represented parametrically by x=p+tu where p is a 3D point, u is a unit vector and t is a free parameter, and similarly the viewing ray is represented parametrically by x=q+sv where q is a 3D point, v is a unit vector and s is a free parameter, then the surface point can be estimated by the method of triangulation as q+s₀v, where w=q−p, and

$${s}_{0} = \frac{- v \cdot w + ( u \cdot v ) ( u \cdot w )}{1 - {( u \cdot v )}^{2}} .$$

The estimated point is the 3D point on the viewing ray that is closest to the illumination ray. The depth value of this 3D point is then taken as the depth value of the point on the surface of the object.

### <Multiple Luminaires>

In the previous section, a single luminaire is used to encode (m+1)² illumination directions. For m=8, this is limited to only 81 directions. To alleviate this limitation, a design using a plurality of luminaires surrounding the object has been considered. FIG. 7 illustrates an example cross-section of such a design.

FIG. 7 is a view for illustrating an example system for illumination direction coding using a plurality of luminaires. Briefly, each of the plurality of luminaires includes multiple pixel-layers with overlapping fields of illumination. The system of FIG. 7 includes a pattern displaying module constructed to cause each pixel-layer of each luminaire to simultaneously and in synchronization with each other display multiple coded patterns. Multiple coded patterns uniquely identify the luminaire causing the reflection and combinations of the multiple coded patterns to further uniquely identify directions of light rays originating from the multiple pixel-layers of the identified luminaire. The system of FIG. 7 further includes a camera constructed to capture one or more images of the object. A direction determining module is constructed to determine, for each pixel of the captured one or more images, a unique light ray direction by decoding the combinations of the multiple coded patterns. A depth recovering module is constructed to recover the surface geometry of the object using the determined unique incident light ray direction for each pixel of the one or more captured images. Moreover, the direction determining module determines the unique light ray direction by determining an identity of one of the luminaires that the light ray originates from by decoding the combinations of the multiple coded patterns. In some examples of the multiple luminaire setup, pixels in the multiple pixel-layers of a luminaire of the plurality of luminaires may have the same dot pitch and aspect ratio.

More specifically, an 8×8 array of luminaires each consisting of pixel-layers of pixel resolution 128×128 are deployed such that the resultant admissible region is the intersection of admissible regions of the luminaires and such that the luminaires surround the resultant admissible region within which the object is to be placed.

In the system of FIG. 7, there are now a total of 8²×9²=5184 coded illumination directions. Although each luminaire can only encode 9² different light directions as explained before, by arranging each luminaire to be at a different angular position relative to the object/admissible region and also designing the shear axis differently for each luminaire, it is ordinarily possible for each of the 8² luminaires to encode a different set of 9² light directions, so that the plurality of luminaries is able to encode a total of 8²×9²=5184 different light directions.

Because the total number of pixels is 1024×1024, the same 10-bit “long run” Gray code can be spread out across multiple luminaires. However, in order to identify which luminaire an individual light ray originates from, it is necessary to use an extra 2×3=6 patterns (because 2³×2³ is the number of luminaires). In an example embodiment, the most significant 3 bits of the standard 10-bit reflected Gray code are used to generate these additional vertical and horizontal stripe patterns.

The following Table I is a comparison of the number of image captures required in the system of FIG. 7 compared to the number of image captures required in the setup described by Tin, et al.

TABLE I

| | Multiple Luminaires | Tin, et al. |
|---|---|---|
| Direct Patterns Only | 26 Image Captures | 40 Image Captures |
| Direct | 46 Image Captures | 80 Image Captures |
| and Inverse Patterns | | |
| (Robust Binarization) | | |

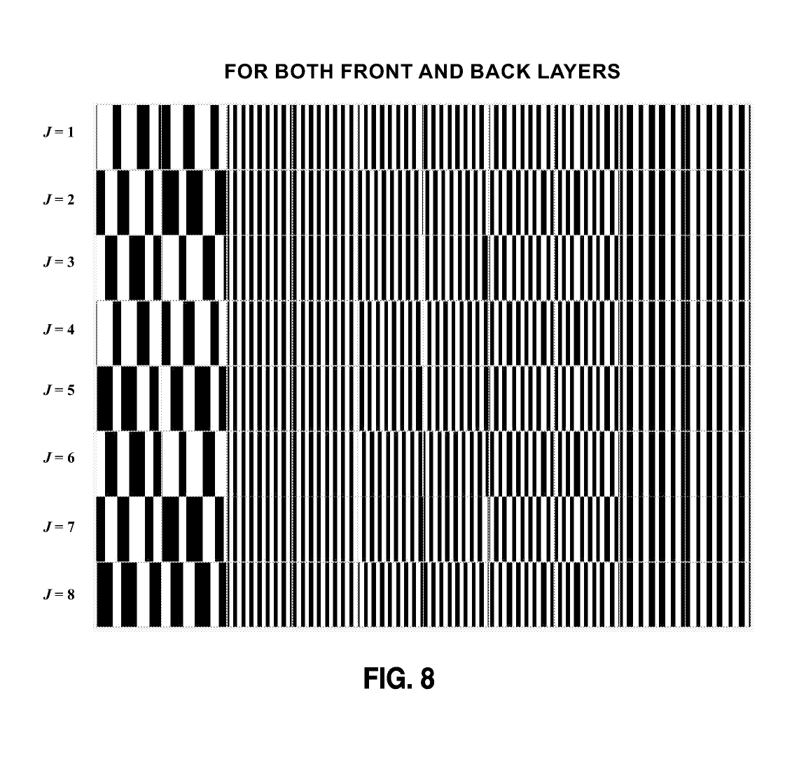

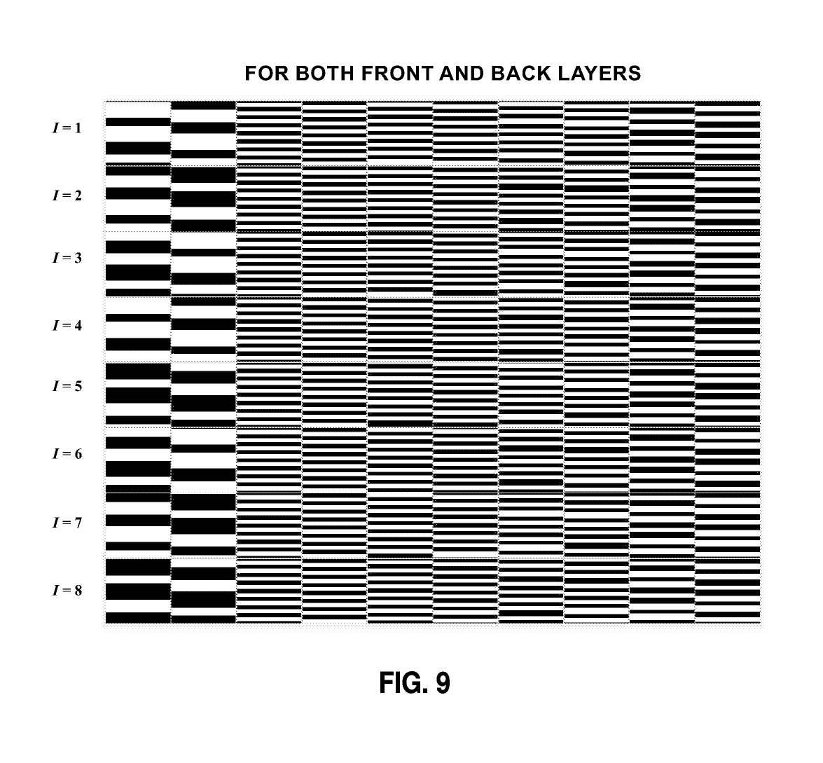

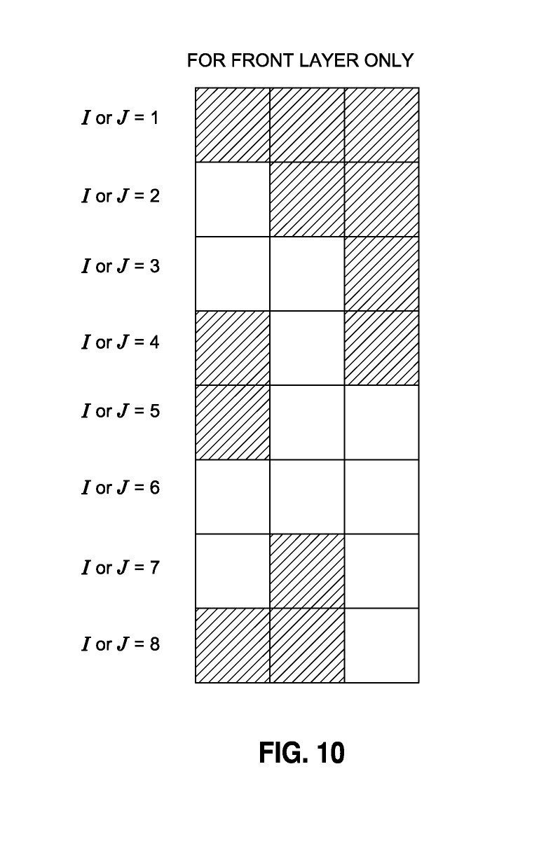

FIGS. 8, 9 and 10 illustrate the binary patterns displayed on each luminaire of the example setup of FIG. 7. For brevity, only the direct patterns are shown (i.e. no inverse patterns). Each luminaire is identified by index pair (I,J) ∈, {1,2, . . . , 8}×{1,2, . . . , 8}. The patterns displayed depend on the identity of the luminaire. For the first 20 patterns, both the front and the back pixel-layers display the same patterns simultaneously and in synchronization with each other. The first 10 (vertical) patterns are determined only by J, as shown in FIG. 8, i.e., luminaires with the same J display the same of one of these patterns at a given time, while the next 10 (horizontal) patterns are determined only by I, as shown in FIG. 9, i.e., luminaires with the same I display the same of one of these patterns at a given time. As shown in FIG. 10, for the last 6 patterns, the front pixel-layer displays a changing pattern, while the back pixel-layer displays a uniformly constant screen, e.g., a full screen of white. In addition, the first 3 patterns are determined by J and the last 3 patterns are determined by I.

For the purpose of measuring the surface normal vector field of the object, the final steps are as follows. The above-described pattern coding allows for the recovery of the unique incident light direction for a specular reflection that a camera pixel records. Assuming that the camera is geometrically calibrated, the camera ray (i.e. camera viewing direction) for the pixel can be determined. The normal vector is then recovered as the half-way vector between the incident light direction and the camera viewing direction.

Additionally, Tin et al. describes spectral multiplexing for color displays as a way to further reduce the number of required image captures by a factor of C, where C is the number of color channels. Because color filters do not change the polarization state, the layers still combine in each color channel according to the XOR logical operation. Accordingly, the above-described methods of illumination direction coding can take advantage of spectral multiplexing as well.

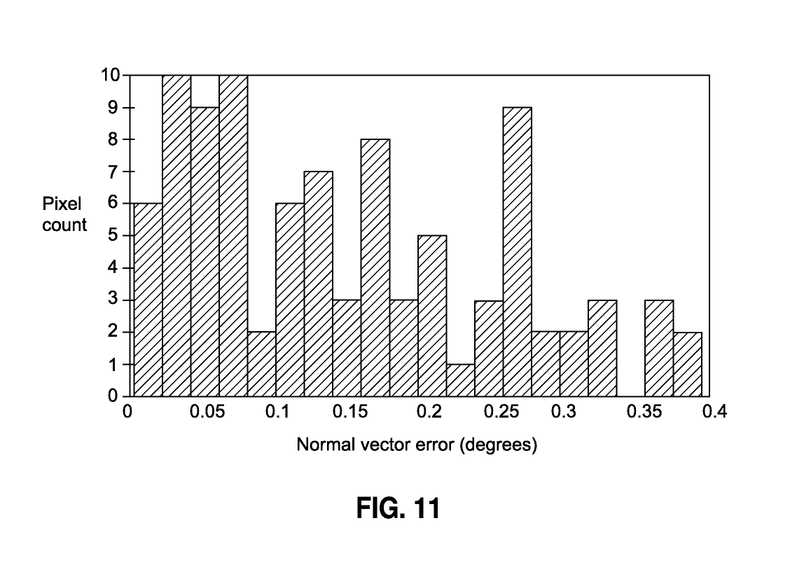

FIG. 11 is a plot of results for the multiple luminaire setup of FIG. 7. The multiple luminaire setup is for the 2D case with a camera having 512 pixels. The object is a sphere (i.e. circle in 2D) with radius 12 mm, chosen so that the whole sphere lies within the resultant admissible region.

In this 2D case, the number of required image captures is 13. Implementation using the standard reflected Gray code of Tin, et al. requires 20 image captures. The two methods yielded identical results, confirming that when the object is located within the admissible region, light rays that do not reach the admissible region have no effect on the results of the measurements.

Out of 512 camera pixels, 92 pixels capture a reflection. The surface normal vectors for these 92 pixels are reconstructed. FIG. 11 shows the histogram of the normal vector errors (in degrees). The mean normal vector error is 0.15 degrees.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be local such as by access via a local memory bus structure, or may be remote such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors constructed to work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

1. A method of measuring a surface geometry of an object, comprising:
capturing one or more images of the object illuminated by a light field produced by a luminaire having multiple pixel-layers with overlapping fields of illumination, wherein each pixel-layer simultaneously and in synchronization with each other displays multiple coded patterns such that combinations of the multiple coded patterns uniquely identify directions of light rays originating from the multiple pixel-layers;
determining a unique incident light ray direction for one or more pixels of the captured one or more images by decoding the combinations of the multiple coded patterns; and
recovering the surface geometry of the object using the determined unique incident light ray direction for each of the one or more pixels of the one or more captured images.

2. The method according to claim 1, wherein recovering the surface geometry of the object comprises determining a surface normal vector field of the object based on the determined unique incident light ray direction for each of the one or more pixels of the one or more captured images.

3. The method according to claim 1, wherein recovering the surface geometry of the object comprises determining points on the surface of the object by triangulation of the unique incident light ray direction and a viewing direction for each of the one or more pixels of the one or more captured images.

4. The method according to claim 1, wherein pixels in the multiple pixel-layers have the same dot pitch and aspect ratio.

5. The method according to claim 1, wherein the combinations of the multiple coded patterns encode differences in pixel location coordinates of pixels located on two of the multiple pixel-layers.

6. The method according to claim 1, wherein at least two of the multiple pixel-layers are largely in parallel to each other and separated by a perpendicular distance.

7. The method according to claim 6, wherein the multiple pixel-layers are positioned such that they are laterally shifted relative to each other.

8. The method according to claim 5, wherein each pixel of a pixel-layer is associated with an admissible cone that determines a maximum difference in pixel location coordinates that can be encoded.

9. The method according to claim 1, wherein the multiple coded patterns are based on a binary Gray code.

10. The method according to claim 9, wherein a minimum-run-length (MRL) of the binary Gray code determines a maximum difference in pixel location coordinates of pixels located on two of the multiple pixel-layers that can be encoded.

11. The method according to claim 9, wherein the minimum-run-length (MRL) of the binary Gray code is 8.

12. A system for measuring a surface geometry of an object comprising:
a plurality of luminaires, each luminaire including multiple pixel-layers with overlapping fields of illumination and the luminaires being positioned to surround the object, wherein multiple coded patterns are displayed on each pixel-layer of each of the plurality of luminaires simultaneously and in synchronization with each other, combinations of the multiple coded patterns uniquely identifying directions of light rays originating from the multiple pixel-layers of each of the luminaires and the multiple coded patterns uniquely identifying each of the luminaires;
an image capture device for capturing one or more images of the object; and
at least one processor constructed to execute computer-executable process steps stored in a computer-readable memory, wherein the process steps stored in the memory cause the at least one processor to:
determine for one or more pixels of the captured one or more images a unique light ray direction by decoding the combinations of the multiple coded patterns; and
recover the surface geometry of the object using the determined unique incident light ray direction for each of the one or more pixels of the one or more captured images.

13. The system according to claim 12, wherein determining the unique light ray direction includes determining an identity of one of the luminaires that the light ray originates from by decoding the combinations of the multiple coded patterns.

14. The system according to claim 12, wherein pixels in the multiple pixel-layers of a luminaire of the plurality of luminaires have the same dot pitch and aspect ratio.

15. A non-transitory computer-readable storage medium storing a program for causing a computer to implement the method according to claim 1.
